(19) United States
(12) Patent Application Publication
(10) Pub. No.: US 2018/0292507 A1
(43) Pub. Date: Oct. 11, 2018

(54) PAYLOAD OF A POSITIONING SYSTEM MEASUREMENT SATELLITE, AND POSITIONING METHOD

(71) Applicant: AIRBUS DEFENCE AND SPACE SAS, TOULOUSE CEDEX 4 (FR)

(72) Inventors: FRÉDÉRIC VOULOUZAN, TOULOUSE CEDEX 4 (FR); RAPHAËL SANCHEZ, TOULOUSE CEDEX 4 (FR); JEAN-MARC AYMES, TOULOUSE CEDEX 4 (FR)

(21) Appl. No.: 15/756,575

(22) PCT Filed: Aug. 31, 2016
(86) PCT No.: PCT/FR2016/052153

§ 371 Date: Jun. 25, 2018

(30) Foreign Application Priority Data
Sep. 3, 2015 (FR) 1558170

(51) Int. Cl. G01S 5/02; G01S 5/06; H04K 3/00

(52) U.S. Cl. CPC G01S 5/0273; H04K 3/22; G01S 5/06

(57) ABSTRACT

A payload of a satellite to measure a positioning system of an earth-based transmitter of a target signal received by a main satellite. A direct receiver of the payload is configured to measure the target signal directly received from the earth-based transmitter. An indirect receiver of the payload is configured to measure the target signal retransmitted by the main satellite. A transmitter of the payload is configured to transmit, to an earth-based station of the positioning system, (i) a group of signals, referred to as homologous signals, measured by the direct receiver and the indirect receiver, and/or (ii) data determined based on the homologous signals. The homologous signals correspond to the target signal received from the earth-based transmitter and the main satellite, respectively. A positioning system and method are also provided herein.

### TECHNICAL FIELD

The present invention belongs to the field of satellite telecommunication systems, and more particularly relates to locating a terrestrial transmitter of a target signal that is received by a satellite of a satellite telecommunication system.

The present invention particularly advantageously applies to locating interfering transmitters, but can be applied more generally to locating any type of terrestrial transmitter.

### PRIOR ART

In general, the term “satellite of a satellite telecommunication system” is understood to mean any satellite that is adapted to receive, over an uplink, data transmitted from the Earth, and for retransmitting (transparently or regeneratively), over a downlink, all or part of said data back to the Earth.

Satellite telecommunication systems are very sensitive to interfering transmitters. Specifically, an interfering signal received over the uplink of a satellite will be retransmitted over the downlink of said satellite and will interfere with numerous communications carried out via said satellite.

It is therefore particularly important to be able to detect and locate such interfering transmitters, to be able to take measures to put an end to the interference. These measures are, for example, contacting the local authorities responsible for the interfering transmitter to get them to stop the transmission of the interfering signal.

The current methods for locating an interfering transmitter of an interfering signal that is received by a satellite, referred to as the main satellite, are based on the use of at least one other satellite, referred to as the mirror satellite, which also receives said interfering signal. The main satellite and the mirror satellite both retransmit the interfering signal to respective ground stations of a locating system, and the interfering signals received by these ground stations may be used to determine the location of the interfering transmitter.

Conventionally, the location of the interfering transmitter may then be determined according to, in particular, measurements of the difference:
between the time of arrival of the interfering signal at the main satellite and the time of arrival of said interfering signal at the mirror satellite, referred to as TDOA (time difference of arrival) measurements;
between the frequency of arrival of the interfering signal at the main satellite and the frequency of arrival of said interfering signal at the mirror satellite, referred to as FDOA (frequency difference of arrival) measurements.

The main drawback of the current locating methods resides in the fact that the presence of a mirror satellite, for a given main satellite receiving an interfering signal, cannot always be guaranteed. Specifically, the presence of a mirror satellite is dependent on a number of constraints:
the main satellite and the mirror satellite must each include a channel, over their respective uplinks, covering both the frequency of the interfering signal from the terrestrial transmitter and the geographical area in which said interfering transmitter is located;
the main satellite and the mirror satellite must have, in each of the geographical areas covered by their respective downlinks, a ground station of the locating system to allow the interfering signals retransmitted by said main satellite and said mirror satellite to be picked up (to be able, ultimately, to determine TDOA measurements and FDOA measurements).

To guarantee the presence of a mirror satellite for a main satellite in geosynchronous orbit, it is known practice, from patent FR 2801682 B1, to use a measurement satellite, dedicated to the mirror function, in a low or medium traveling orbit. The traveling orbit of the measurement satellite is such that said measurement satellite covers, at least temporarily, the geographical area covered by the main satellite.

However, the locating system described by patent FR 2801682 B1 always requires the presence, in each of the geographical areas covered by the respective downlinks of the main satellite and of the measurement satellite, a ground station of the locating system, which cannot always be guaranteed.

### SUMMARY OF THE INVENTION

One objective of the present invention is to overcome all or some of the limitations of the solutions of the prior art, in particular those summarized above, by providing a solution that makes it possible to guarantee the presence of a mirror satellite for a main satellite.

Additionally, another objective of the present invention is to provide a solution that makes it possible to decrease the constraints linked to the presence, in each of the geographical areas covered by the respective downlinks of the main satellite and of the mirror satellite, of a ground station of the locating system.

To this end, and according to a first aspect, the invention relates to a payload of a measurement satellite of a system for locating a terrestrial transmitter of a target signal that is received by a main satellite in an Earth orbit over an uplink of said main satellite, said payload being intended to be placed with said measurement satellite in a traveling Earth orbit intercepting a downlink of said main satellite, said payload including a direct reception module that is adapted to measure said target signal received directly from the terrestrial transmitter. The payload further includes an indirect reception module that is adapted to measure the target signal retransmitted by the main satellite over the downlink of said main satellite, and a transfer module that is adapted to transmit, to a ground station of the locating system:
a group of signals, referred to as homologous signals, that are measured by the direct reception module and the indirect reception module and that correspond to the target signal received from the terrestrial transmitter and from the main satellite, respectively; and/or
data that are determined on the basis of said homologous signals.

Thus, the invention is based on the use of a payload on board a measurement satellite in a traveling Earth orbit, such that it will always be possible, by choosing a suitable traveling Earth orbit, to receive the target signal transmitted by the terrestrial transmitter, i.e. to perform the mirror function for locating said terrestrial transmitter.

Additionally, the measurement satellite carrying this payload also performs another function, namely a function of picking up the target signal retransmitted by the main satellite over its downlink.

Thus, the presence of a ground station of the locating system in the geographical area covered by the downlink of the main satellite is no longer necessary, since it is the measurement satellite that picks up the target signal retransmitted by the main satellite, while simultaneously performing the mirror function for locating the terrestrial transmitter.

In particular embodiments, the payload may further include one or more of the following features, taken individually or in all technically possible combinations.

In particular embodiments, the payload includes a processing module that is adapted to memorize the homologous signals.

Such arrangements are particularly advantageous in that it is then no longer necessary for a ground station of the locating system to be present in the geographical area covered by the downlink of the measurement satellite when measuring the homologous signals. Specifically, by virtue of this memorization capability of the payload of the measurement satellite, the transfer of the homologous signals (or of data deduced from said homologous signals) could be deferred for a time until the geographical area covered by the downlink of said measurement satellite (which varies with time because said measurement satellite is in a traveling Earth orbit) encompasses a ground station of the locating system.

In particular embodiments, the payload includes a local oscillator that is common to the direct reception module and to the indirect reception module.

In the locating systems of the prior art, numerous mutually independent reception chains are implemented at the mirror satellite, at the main satellite and at the ground stations of the locating system. These reception chains include in particular respective local oscillators that introduce respective mutually independent frequency instabilities, which affect the accuracy of the frequency measurements. Because one and the same local oscillator is used both by the direct reception module (mirror function) and by the indirect reception module (function of picking up the target signal retransmitted by the main satellite, performed by a ground station in the locating systems of the prior art), the accuracy of the frequency measurements and, ultimately, that of locating the terrestrial transmitter, is improved. Specifically, the frequency instabilities introduced by this local oscillator are the same for each of the homologous signals, and are removed by means of a differential analysis of said homologous signals.

In particular embodiments, the direct reception module and the indirect reception module each include multiple radiofrequency reception chains that are adapted to receive signals in different respective frequency bands.

In particular embodiments, the payload includes a module for transmitting a calibration signal over the uplink of the main satellite. The calibration signal is for example a signal of the type having a spectrum spread by a spectrum spreading code.

According to a second aspect, the present invention relates to a system for locating a terrestrial transmitter of a target signal that is received by a main satellite in an Earth orbit over an uplink of said main satellite, including:
a measurement satellite including a payload according to any one of the embodiments of the invention, said measurement satellite being in a traveling Earth orbit intercepting a downlink of said main satellite;
means that are configured to determine information on the location of the terrestrial transmitter by comparing the homologous signals measured by said measurement satellite;
means that are configured to determine the location of the terrestrial transmitter according to the location information.

In particular embodiments, the locating system may further include one or more of the following features, taken individually or in all technically possible combinations.

In particular embodiments, the means that are configured to determine the location information are on board the measurement satellite.

In particular embodiments, the means that are configured to determine the location of the terrestrial transmitter are on board the measurement satellite, and the transfer module is configured to transmit the location of the terrestrial transmitter to a ground station.

In particular embodiments, the transfer module is configured to transmit the location information to a ground station, and the means that are configured to determine the location of the terrestrial transmitter are held in one or more ground stations.

In particular embodiments, the transfer module is configured to transmit the homologous signals to a ground station, and the means that are configured to determine the location information and the means that are configured to determine the location of the terrestrial transmitter are held in one or more ground stations.

In particular embodiments, location information of at least one type is determined, from the following types:
the difference between the time of arrival of the target signal received by the direct reception module and the time of arrival of the target signal received by the indirect reception module;
the difference between the frequency of arrival of the target signal received by the direct reception module and the frequency of arrival of the target signal received by the indirect reception module;
the difference between the Doppler frequency of arrival of the target signal received by the direct reception module and the Doppler frequency of arrival of the target signal received by the indirect reception module.

According to a third aspect, the present invention relates to a method for locating a terrestrial transmitter of a target signal that is received by a main satellite in an Earth orbit over an uplink of said main satellite, including steps of:
measuring a group of homologous signals by means of a measurement satellite including a payload according to any one of the embodiments of the invention;
determining information on the location of the terrestrial transmitter by comparing the homologous signals measured by said measurement satellite;
determining the location of the terrestrial transmitter according to the location information.

In particular modes of implementation, the locating method may further include one or more of the following features, taken individually or in all technically possible combinations.

In particular modes of implementation, location information of at least one type is determined, from the following types:
the difference between the time of arrival of the target signal received by the direct reception module and the time of arrival of the target signal received by the indirect reception module;
the difference between the frequency of arrival of the target signal received by the direct reception module and the frequency of arrival of the target signal received by the indirect reception module;
the difference between the Doppler frequency of arrival of the target signal received by the direct reception module and the Doppler frequency of arrival of the target signal received by the indirect reception module.

In particular modes of implementation, multiple groups of homologous signals are measured at different respective measurement times, and location information is determined for each group of homologous signals.

In particular modes of implementation, differential location information is determined according to the location information determined for different measurement times.

In particular modes of implementation, the locating method includes steps of:
transmitting, by the measurement satellite, a calibration signal over the uplink of the main satellite;
determining calibration information by comparing the calibration signal transmitted by the measurement satellite with the signal corresponding to said calibration signal received by the indirect reception module of said measurement satellite;
calibrating the location information according to the calibration information.

According to a fourth aspect, the present invention relates to a computer program product including a set of program code instructions that, when they are run by a processor, configure said processor to implement a method for locating a terrestrial transmitter according to any one of the modes of implementation of the invention.

### PRESENTATION OF THE FIGURES

The invention will be better understood upon reading the following description provided by way of completely nonlimiting example and with references to the figures, which show:

FIG. 1: a schematic representation of one exemplary embodiment of a locating system;

FIG. 2: a diagram representing the main steps of one exemplary mode of implementation of a locating method;

FIG. 3: a schematic representation of one preferred embodiment of a measurement satellite for a locating system; and

FIG. 4: a diagram representing the main steps of one preferred mode of implementation of a locating method.

In these figures, references that are the same from one figure to the next denote elements that are identical or analogous. For the sake of clarity, the elements are not shown to scale, unless stated otherwise.

### DETAILED DESCRIPTION OF EMBODIMENTS

FIG. 1 shows a schematic representation of one exemplary embodiment of a system 10 for locating a terrestrial transmitter 30 of a target signal that is received by a satellite in an Earth orbit, referred to as the “main satellite 20”, belonging to a satellite telecommunication system.

The term “satellite of a satellite telecommunication system” is understood to mean any satellite that is adapted to receive, over an uplink, data transmitted from the Earth, and for retransmitting (transparently or regeneratively), over a downlink, all or part of said data back to the Earth.

As illustrated by FIG. 1, the locating system 10 includes a measurement satellite 40 in a traveling Earth orbit.

In general, the invention can be applied to any type of Earth orbit for the main satellite 20 and the measurement satellite 40, as long as the traveling Earth orbit of the measurement satellite 40 intercepts the downlink of the main satellite 20, i.e. as long as the measurement satellite 40 in this traveling Earth orbit may be located, at least temporarily, in a position in which it may receive data retransmitted over the downlink by said main satellite 20.

The traveling Earth orbit of the measurement satellite 40 must, for this purpose, be at an altitude that is lower than that of the Earth orbit of the main satellite 20. The present invention is therefore particularly advantageously, but completely non-limitingly, applicable to the case of a main satellite 20 in a geosynchronous orbit and to the case of a measurement satellite 40 in a low or medium orbit. Throughout the remainder of the description, it will be assumed, in a nonlimiting manner, that the main satellite 20 is in a geostationary orbit (GEO). The measurement satellite 40 is for example a few thousand kilometers below the geostationary arc, and as a result it will travel with respect to the main satellite 20 that is in a GEO orbit and, more generally, with respect to all satellites in a GEO orbit. One and the same measurement satellite 40 may therefore be used, over time, to locate terrestrial transmitters with respect to various satellites in a GEO orbit.

As illustrated by FIG. 1, the measurement satellite 40, in such a traveling Earth orbit, is therefore adapted to receive the target signal in two different ways:
directly from the terrestrial transmitter 30, via a direct path T1 between said terrestrial transmitter 30 and the measurement satellite 40;
by way of the main satellite 20, via an indirect path T2, said main satellite 20 retransmitting, over its downlink, the target signal received over its uplink.

Advantageously, the measurement satellite 40 therefore holds a payload including a direct reception module 41 that is adapted to measure said target signal received over the direct path T1, and an indirect reception module 42 that is adapted to measure the target signal received over the indirect path T2. The direct reception module 41 and the indirect reception module 42 both take the form, for example, of conventional radiofrequency reception chains, each including at least one antenna for receiving radiofrequency signals, a low-noise amplifier, etc.

Thus, the direct reception module 41 and the indirect reception module 42 measure a group of signals, referred to as “homologous signals”, which correspond to the same target signal having taken two different paths, namely the direct path T1 and the indirect path T2, respectively.

The measurement satellite 40 also includes a transfer module 43 that is adapted to transmit, to a ground station 50 of the locating system 10, said homologous signals and/or data determined on the basis of said homologous signals. The transfer module 43 takes the form, for example, of a conventional radiofrequency transmission chain, including at least one antenna for transmitting radiofrequency signals, a power amplifier, etc.

In the nonlimiting example illustrated by FIG. 1, the homologous signals and/or data are transmitted directly to the ground station 50. However, according to other examples, there is nothing to rule out the homologous signals and/or data being transmitted indirectly to said ground station 50, for example via other satellites (not shown).

The homologous signals may for example be transferred to the ground station 50 immediately after their reception, in particular if the ground station 50 is located within the geographical area covered by a downlink of said measurement satellite 40, as is the case in the nonlimiting example illustrated by FIG. 1.

In preferred embodiments, the payload of the measurement satellite 40 further includes a processing module 44 that is adapted to memorize the homologous signals. Such arrangements are particularly advantageous in that the ground station 50 does not necessarily have to be located within the geographical area covered by the downlink of the measurement satellite 40. Specifically, the homologous signals may be memorized until a ground station 50 comes into said geographical area, following the travel of said measurement satellite 40. The locating system 10 thus obtained may therefore operate autonomously without the immediate availability of a ground station 50, since the homologous signals are picked up and memorized by the measurement satellite 40.

The processing module 44 includes for example analog-to-digital conversion means, at least one processor and at least one electronic memory in which a computer program product is stored, in the form of a set of program code instructions to be run for the purpose of performing the operations carried out by the payload of the measurement satellite 40 in respect of locating the terrestrial transmitter 30, in particular the operations for memorizing the homologous signals. Alternatively or additionally, the processing module 44 may include one or more programmable logic devices (FPGA, PLD, etc.), and/or one or more specialized integrated circuits (ASIC), and/or a set of discrete electronic components, etc., which are adapted to implement all or some of said operations carried out by the payload of the measurement satellite 40 in respect of locating the terrestrial transmitter 30.

Stated otherwise, the processing module 44 includes a set of means that are configured on the basis of software (specific computer program product) and/or hardware (FPGA, PLD, ASIC, discrete electronic components, etc.) for implementing the operations carried out by the payload of the measurement satellite 40 in respect of locating the terrestrial transmitter 30.

Analogously, the ground station 50 of the locating system 10 includes a set of means that are configured on the basis of software (specific computer program product) and/or hardware (FPGA, PLD, ASIC, etc.) for implementing the operations carried out by said ground station 50 in respect of locating the terrestrial transmitter 30.

As mentioned above, the transfer module 43 of the payload of the measurement satellite 40 transmits, to the ground station 50 of the locating system 10, the homologous signals and/or data determined on the basis of said homologous signals. In the case in which data are determined on the basis of said homologous signals, by the processing module 44 if applicable, said data correspond to location information (discussed below), or even directly to the location of the terrestrial transmitter 30 if the measurement satellite 40.

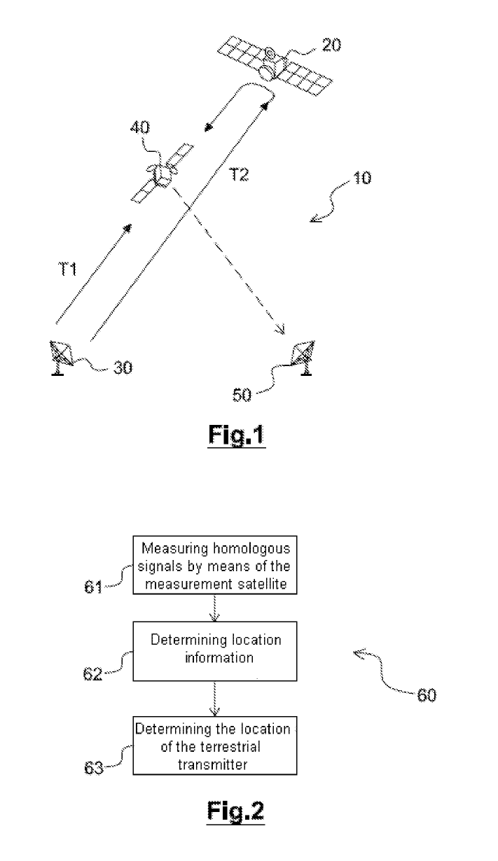

FIG. 2 schematically shows the main steps of one exemplary mode of implementation of a locating method 60, which are:
61 measuring a group of homologous signals by means of the measurement satellite 40;
62 determining information on the location of the terrestrial transmitter 30 by comparing the homologous signals;
63 determining the location of the terrestrial transmitter 30 according to the location information.

As mentioned above, the homologous signals correspond to the same target signal having taken two different paths, namely the direct path T1 and the indirect path T2, respectively.

With respect to the prior art, the measurement of the homologous signal over the direct path T1 corresponds to the mirror function, while the measurement of the homologous signal over the indirect path T2 corresponds to the function of picking up the target signal received by the main satellite 20.

Consequently, the operation of locating the terrestrial transmitter 30 may make use of methods known to those skilled in the art, applied to the homologous signals, and the steps 62 of determining location information and 63 of determining the location of the terrestrial transmitter 30 are considered to be known to those skilled in the art. For example, it is possible to determine, on the basis of the homologous signals, location information of at least one type from the following types:
the difference between the time of arrival of the target signal received by the direct reception module 41 and the time of arrival of the target signal received by the indirect reception module 42 (TDOA measurements);
the difference between the frequency of arrival of the target signal received by the direct reception module 41 and the frequency of arrival of the target signal received by the indirect reception module 42 (FDOA measurements);
the difference between the Doppler frequency of arrival of the target signal received by the direct reception module 41 and the Doppler frequency of arrival of the target signal received by the indirect reception module 42 (DDOA measurements—“Doppler difference of arrival”).

On the basis of such location information, it is possible to deduce the location of the terrestrial transmitter 30, potentially while taking into account additional information, such as the respective positions of the measurement satellite 40 and of the main satellite 20.

In a known manner, a TDOA measurement is proportional to the difference in distance, on the one hand, between the main satellite 20 and the terrestrial transmitter 30 and, on the other hand, the sum of:
the distance between the main satellite 20 and the measurement satellite 40 (which may be calculated if their respective positions are known);
the distance between the main satellite 20 and the terrestrial transmitter 30.

An FDOA measurement is linked to the relative velocity between the various objects under consideration, while a DDOA measurement is linked to the variation in the relative velocity between the various objects under consideration.

For each of these TDOA, FDOA, or DDOA measurements, it is possible to identify the set of compatible points on the Earth, in the form of iso-TDOA, iso-FDOA or iso-DDOA curves. The intersections between these curves allow the location of the terrestrial transmitter 30 to be determined.

In particular modes of implementation, location information of at least two different types from the above types are determined in step 62.

Additionally or alternatively, the locating method 60 includes, in particular modes of implementation, measuring multiple groups of homologous signals at different respective measurement times, location information being determined for each group of homologous signals. Such arrangements make it possible to improve the accuracy of locating the terrestrial transmitter 30.

In preferred modes of implementation, the locating method 60 includes determining differential location information by comparing the location information determined for different measurement times, the location of the terrestrial transmitter 30 being determined according to said differential location information. For example, in the case of TDOA measurements, the differential location information corresponds to the difference between TDOA measurements that are associated with different measurement times (DTDOA—“differential time difference of arrival” measurements). Similarly, for FDOA measurements, the differential location information corresponds to the difference between FDOA measurements that are associated with different measurement times (DFDOA—“differential frequency difference of arrival” measurements), etc.

Using differential location information is advantageous in a number of cases.

For example, it is not possible to use TDOA measurements for substantially sinusoidal target signals (CW—“continuous-wave” signals). The use of FDOA measurements and/or DDOA measurements may then prove to be insufficient for removing the ambiguities with respect to the position of the terrestrial transmitter 30. It will usually be possible to remove these ambiguities by means of DFDOA measurements and/or DDDOA measurements.

Additionally, using FDOA measurements and/or DDOA measurements is complex in the case of mobile terrestrial transmitters 30. Such mobile terrestrial transmitters 30 could however be located using DTDOA measurements.

Additionally, in the locating systems of the prior art, it is generally necessary to use one or more ground stations having known positions, referred to as “reference stations”, to transmit a known reference signal in the direction of the main satellite and of the mirror satellite, in order to determine measurement biases and to compensate therefor. For example, TDOA measurements are generally affected by measurement biases linked to the internal latency of the main satellite, the internal latency of the mirror satellite, etc. FDOA measurements are themselves generally affected by measurement biases linked to the respective drifts of the various local oscillators (local oscillators of the main satellite, local oscillators of the mirror satellite). DDOA measurements are themselves generally affected by measurement biases linked to uncertainties regarding the respective positions of the main satellite and of the mirror satellite. Using differential location information makes it possible to remove these measurement biases, provided that they may be considered to be substantially constant from one measurement time to the next. Thus, using differential location information makes it possible to have a locating system 10 without reference stations.

As mentioned above, the steps 62 of determining location information and 63 of determining the location of the terrestrial transmitter 30 may be fully or partly carried out at the measurement satellite 40, or by the processing module 44 if applicable.

According to a first example, the location information and the location of the terrestrial transmitter 30 are determined by the measurement satellite 40. The locating method 60 then includes a step of transferring the location of the terrestrial transmitter 30 to a ground station 50 of the locating system 10.

According to a second example, the location information is determined by the measurement satellite 40 and the location of the terrestrial transmitter 30 is determined by one or more ground stations 50 of the locating system 10. The locating method 60 then includes a step of transferring the location information to a ground station 50 of said locating system 10.

According to a third example, the location information and the location of the terrestrial transmitter 30 are determined by one or more ground stations 50 of the locating system 10. The locating method 60 then includes a step of transferring the homologous signals to a ground station 50 of said locating system 10.

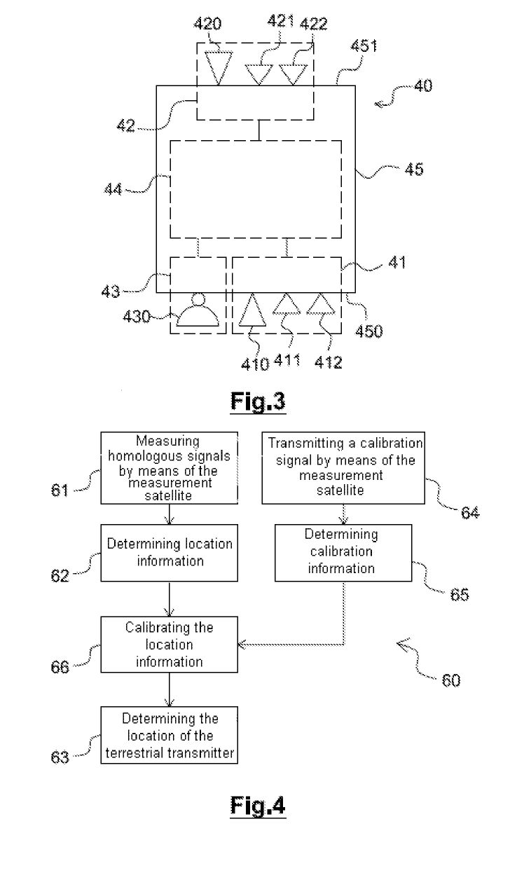

FIG. 3 schematically shows, by way of nonlimiting example, one preferred embodiment of a measurement satellite 40.

As illustrated by FIG. 3, the measurement satellite 40 includes a body 45 which is substantially in the shape of a parallelepipedal rectangle, in this instance substantially in the shape of a cube in the nonlimiting example illustrated by FIG. 3.

The respective antennas of the direct reception module 41 and of the indirect reception module 42 are for example arranged on opposite faces of the body 45:
for the direct reception module 41: on a face of the measurement satellite 40, referred to as the “Earth face” 450, that is intended to be directed toward the Earth during operations in the traveling Earth orbit;
for the indirect reception module 42: on a face of the measurement satellite 40, referred to as the “anti-Earth face” 461, that is opposite the Earth face 450 of said measurement satellite 40.

In preferred embodiments, the direct reception module 41 and the indirect reception module 42 each include multiple radiofrequency reception chains that are adapted to receive signals in different frequency bands.

In the example illustrated by FIG. 3, the direct reception module 41 includes a C-band reception chain, a Ku-band reception chain and a Ka-band reception chain, including respective antennas 410, 411, 412 that are all arranged on the Earth face 450 of the body 45. The indirect reception module 42 also includes a C-band reception chain, a Ku-band reception chain and a Ka-band reception chain, including respective antennas 420, 421, 422 that are all arranged on the anti-Earth face 461 of the body 45.

The antennas 410-412, 420-422 of the direct reception module 41 and of the indirect reception module 42 may be of any type that is adapted to receive radiofrequency signals transmitted from the Earth and from the main satellite 20, respectively. In the nonlimiting example illustrated by FIG. 3, the antennas 410-412, 420-422 are horn antennas, but there is nothing to rule out using other types of reception antennas, having for example a higher antenna gain to limit co-frequency interference over the uplink and/or the downlink of the measurement satellite 40.

In preferred embodiments, the reception chains of the direct reception module 41 and the reception chains of the indirect reception module 42 advantageously include shared hardware elements. In particular, the use of one and the same local oscillator both by the direct reception model 41 and by the indirect reception module 42 allows the frequency measurements to be improved.

The transfer module 43 includes for example a radiofrequency transmission chain including an antenna 430 for transmitting radiofrequency signals (for transferring the homologous signals and/or data deduced from said homologous signals). In the example illustrated by FIG. 3, the antenna 430 is arranged on the Earth face 450 of the body 45.

In preferred embodiments, the payload of the measurement satellite 40 includes a transmission module (not shown) that is adapted to transmit a calibration signal over the uplink of the main satellite 20. The calibration signal is for example a signal of the type having a spectrum spread by a spectrum spreading code. Using such a calibration signal is advantageous insofar as the level of the calibration signal per unit frequency may be made lower than the noise floor of the main satellite 20, such that the traffic from the users of said main satellite is not disrupted.

Transmitting, by means of the measurement satellite 40, a calibration signal is advantageous in that it allows the locating system 10 to be calibrated autonomously, without having to use reference stations on the surface of the Earth. Specifically, by comparing the calibration signal transmitted by the measurement satellite 40 with the signal corresponding to said calibration signal received by the indirect reception module 42 of said measurement satellite 40, it is possible, in a conventional manner, to estimate calibration information making it possible to compensate for the various measurement biases of the locating system 10. Transmitting such a calibration signal by means of the measurement satellite 40 also makes it possible to characterize the frequency plan of the main satellite 20, i.e. to determine the associations between the frequencies of the uplink and the frequencies of the downlink of the main satellite 20.

FIG. 4 schematically shows the main steps of one preferred mode of implementation of the locating method 60 using a measurement satellite 40 provided with a module for transmitting a calibration signal. As illustrated by FIG. 4, the locating method 60 includes, along with the steps described above with reference to FIG. 2, additional steps of:
64 transmitting, by the measurement satellite 40, the calibration signal over the uplink of the main satellite 20;
65 determining calibration information by comparing the calibration signal transmitted by the measurement satellite 40 with the signal corresponding to said calibration signal received by the indirect reception module 42 of said measurement satellite 40;
66 calibrating the location information according to the calibration information.

As above, the steps 65 of determining calibration information and 66 of calibrating the location information according to the calibration information may be:
carried out entirely at the measurement satellite 40, or by the processing module 44 if applicable;
carried out entirely at one or more ground stations 50 of the locating system 10, if applicable the calibration signal received by the indirect reception module 42 is transmitted to a ground station 50 of the locating system 10;
distributed between the measurement satellite 40 and one or more ground stations 50 of the locating system 10.

More generally, it should be noted that the modes of implementation and embodiments considered above have been described by way of nonlimiting examples, and that other variants can therefore be envisaged.

In particular, the invention has been described while mainly considering particular embodiments in which the locating system 10 does not include a reference station. However, according to other examples, there is nothing to rule out using reference stations. In particular, using multiple reference stations makes it possible to avoid having to know the respective positions of the main satellite 20 and of the measurement satellite 40.

The above description clearly illustrates that, through its various features and the advantages thereof, the present invention achieves its set objectives. In particular, using a measurement satellite 40 in a traveling orbit that is adapted to intercept the downlink of the main satellite 20 makes it possible to perform the mirror function. In addition, the measurement satellite 40 is adapted to measure the radiofrequency signals transmitted by the main satellite 20 over its downlink, such that said measurement satellite 40 thus also performs the pick-up function that was previously performed by a ground station, the presence of which in the area covered by said downlink of said main satellite 20 could not always be guaranteed.

As described above, the locating system 10 may additionally, in particular embodiments, advantageously be without reference stations, by virtue of the determination of differential location information (DTDOA and/or DFDOA and/or DDDOA measurements) and/or the transmission of a calibration signal by the measurement satellite 40.

In addition, given that the measurement satellite 40 travels with respect to the main satellite 20, the TDOA, FDOA and DDOA measurements vary more substantially than in the case of a main satellite and a mirror satellite that are both in a GEO orbit, such that the accuracy regarding the location of the terrestrial transmitter 30 will be improved.

1-17. (canceled)

18. A payload of a measurement satellite of a system configured to locate a terrestrial transmitter of a target signal received by a main satellite in an Earth orbit over an uplink of the main satellite, the payload is configured to be placed in a traveling Earth orbit intercepting a downlink of the main satellite, and the payload comprising:
a direct receiver configured to measure the target signal received directly from the terrestrial transmitter;
an indirect receiver configured to measure the target signal retransmitted by the main satellite over the downlink of the main satellite; and
a transmitter configured to transmit, to a ground station of the locating system, at least one of the following:
homologous signals measured by the direct receiver and the indirect receiver, the homologous signals correspond to the target signal received from the terrestrial transmitter and from the main satellite, respectively; and
data determined by the payload based on the homologous signals.

19. The payload as claimed in claim 18, further comprising a processor configured to memorize the homologous signals.

20. The payload as claimed in claim 18, further comprising an oscillator common to the direct receiver and the indirect receiver.

21. The payload as claimed in claim 18, wherein each of the direct receiver and the indirect receiver comprises multiple radiofrequency reception chains configured to receive signals in different respective frequency bands.

22. The payload as claimed in claim 18, wherein the transmitter is configured to transmit a calibration signal over the uplink of the main satellite.

23. A system to locate a terrestrial transmitter of a target signal received by a main satellite in an Earth orbit over an uplink of the main satellite, the system comprising:
a measurement satellite comprising the payload as claimed in claim 18, in a traveling Earth orbit intercepting a downlink of the main satellite;
a first processor configured to determine a location information of the terrestrial transmitter by comparing the homologous signals measured by the measurement satellite; and
a second processor configured to determine the location of the terrestrial transmitter based on the location information.

24. The system as claimed in claim 23, wherein the first processor is on board the measurement satellite.

25. The system as claimed in claim 24, wherein the second processor is on board the measurement satellite; and wherein the transmitter is configured to transmit the location of the terrestrial transmitter to the ground station.

26. The system as claimed in claim 24, wherein the transmitter is configured to transmit the location information to the ground station; and wherein the second processor is housed in one or more ground stations.

27. The system as claimed in claim 23, wherein the transmitter is configured to transmit the homologous signals to the ground station; and wherein the first processor and the second processor are housed in one or more ground stations.

28. The system as claimed in claim 23, wherein the location information of at least one type is determined from the following types:
a difference between a time of arrival of the target signal received by the direct receiver and a time of arrival of the target signal received by the indirect receiver;
a difference between a frequency of arrival of the target signal received by the direct receiver and a frequency of arrival of the target signal received by the indirect receiver; and
a difference between a Doppler frequency of arrival of the target signal received by the direct receiver and a Doppler frequency of arrival of the target signal received by the indirect reception module.

29. A method for locating a terrestrial transmitter of a target signal received by a main satellite in an Earth orbit over an uplink of the main satellite, the method comprising steps of:
using a measurement satellite in a traveling Earth orbit intercepting a downlink of the main satellite, wherein measurement satellite comprises a direct receiver configured to measure the target signal received directly from the terrestrial transmitter, an indirect receiver configured to measure the target signal retransmitted by the main satellite over a downlink of the main satellite;
measuring homologous signals by the direct receiver and the indirect receiver of the measurement satellite, the homologous signals correspond to the target signal received from the terrestrial transmitter and from the main satellite, respectively;
determining a location information of the terrestrial transmitter by comparing the homologous signals measured by the measurement satellite; and
determining the location of the terrestrial transmitter based on the location information.

30. The method as claimed in claim 29, wherein the location information of at least one type is determined from the following types:
a difference between a time of arrival of the target signal received by the direct receiver and a time of arrival of the target signal received by the indirect receiver;
a difference between a frequency of arrival of the target signal received by the direct receiver and a frequency of arrival of the target signal received by the indirect receiver; and
a difference between a Doppler frequency of arrival of the target signal received by the direct receiver and a Doppler frequency of arrival of the target signal received by the indirect reception module.

31. The method as claimed in claim 29, wherein multiple groups of homologous signals are measured at different respective measurement times; and wherein the location information is determined for each group of homologous signals.

32. The method as claimed in claim 31, wherein a differential location information is determined based on the location information determined for the different respective measurement times.

33. The method as claimed in claim 29, further comprising steps of:
transmitting, by the measurement satellite, a calibration signal over the uplink of the main satellite;
determining a calibration information by comparing the calibration signal transmitted by the measurement satellite with a signal corresponding to the calibration signal received by the indirect receiver of the measurement satellite; and
calibrating the location information based on the calibration information.

34. A non-transitory computer readable medium comprising a set of executable program code, the code programs a processor to be configured to execute the method as in claim 29 for locating the terrestrial transmitter.
